(19) United States
(12) Patent Application Publication
(10) Pub. No.: US 2020/0375185 A1
(43) Pub. Date: Dec. 3, 2020

(54) LIQUID SUSPENSION CONCENTRATE FORMULATION COMPRISING MEFENTRIFLUCONAZOLE

(71) Applicant: SUMITOMO CHEMICAL COMPANY, LIMITED, Tokyo (JP)

(72) Inventor: Hiroto TADA, Takarazuka-shi (JP)

(73) Assignee: SUMITOMO CHEMICAL COMPANY, LIMITED, Tokyo (JP)

(21) Appl. No.: 16/990,791

(22) Filed: Aug. 11, 2020

Related U.S. Application Data
(63) Continuation of application No. 16/937,352, filed on Jul. 23, 2020.
Application No. 16/937,352 is a continuation of application No. 16/508,004, filed on Jul. 10, 2019, now abandoned.

(30) Foreign Application Priority Data
May 31, 2019 (JP) 2019-102247

(51) Int. Cl. A01N 43/653; A01N 25/30; A01N 25/04

(52) U.S. Cl. CPC A01N 43/653; A01N 25/04; A01N 25/30

(57) ABSTRACT

An object of the present invention is to provide an aqueous suspension concentrate comprising mefentrifluconazole, which hardly precipitates during storage and is inhibited from being separated. An aqueous suspension comprising mefentrifluconazole, one or more surfactants selected from anionic surfactants and nonionic surfactants, and water, and having a zeta potential of −48 to −80 mV.

### CROSS-REFERENCE TO RELATED APPLICATIONS

This application is a Continuation of co-pending U.S. application Ser. No. 16/937,352 filed on Jul. 23, 2020. Application Ser. No. 16/937,352 is a Continuation of U.S. application Ser. No. 16/508,004 filed on Jul. 10, 2019 (now abandoned), which claims priority under 35 U.S.C. § 119(a) to Patent Application No. 2019-102247 filed in Japan on May 31, 2019. The entire contents of which are hereby incorporated by reference.

### BACKGROUND OF THE INVENTION

### Field of the Invention

The present invention relates to a liquid suspension concentrate formulation comprising mefentrifluconazole.

### Description of the Related Art

Conventionally, as one of forms of pesticide formulations, aqueous suspension concentrates referred to as SCs, in which particles of a solid pesticidally active ingredient are suspended in water, are known. SCs have problems such as that, if the particles precipitate during storage, they have to be re-suspended when a user uses them. Thus, it is desirable that SCs hardly precipitate.

Mefentrifluconazole is known as an active ingredient of a plant disease control agent (see, for example, US Patent Application Publication No. 2014/0155262 A and WO 2017/102905).

### CITATION LIST

### Patent Documents

Patent Document 1: US-2014-0155262-A1

Patent Document 2: WO 2017/102905-A1

### SUMMARY OF THE INVENTION

An object of the present invention is to provide an aqueous suspension concentrate comprising mefentrifluconazole, which hardly precipitates during storage and is inhibited from being separated.

The present inventor has intensively studied so as to find an aqueous suspension concentrate comprising mefentrifluconazole, which hardly precipitates during storage and is inhibited from being separated, and found that, by adjusting a value of the zeta potential of an aqueous suspension comprising mefentrifluconazole, one or more surfactants selected from anionic surfactants and nonionic surfactants, and water to be within a specific range, the separation of the suspension can be inhibited.

More specifically, the present invention is as described below.

[1] An aqueous suspension comprising mefentrifluconazole, one or more surfactants selected from anionic surfactants and nonionic surfactants, and water, wherein the aqueous suspension has a zeta potential of −48 to −80 mV.

According to the present invention, it is possible to provide an aqueous suspension concentrate comprising mefentrifluconazole, which hardly precipitates during storage and is inhibited from being separated.

### DETAILED DESCRIPTION OF THE PREFERRED EMBODIMENTS

An aqueous suspension according to the present invention (hereinafter referred to as the suspension of the present invention) comprises mefentrifluconazole.

Mefentrifluconazole is a known compound and described, for example, in US Patent Application Publication No. 2014/0155262 A and WO 2017/102905. Mefentrifluconazole can be synthesized by the method as described in US Patent Application Publication No. 2014/0155262 A and WO 2017/102905.

The suspension of the present invention comprises mefentrifluconazole in an amount of usually 1 to 60% by weight, preferably 3 to 50% by weight.

The suspension of the present invention comprises one or more surfactants selected from anionic surfactants and nonionic surfactants (hereinafter sometimes referred to as the present surfactant(s)). Preferred anionic surfactants are sulfonates, sulfates, phosphates, carboxylates, and mixtures thereof. Examples of sulfonates include naphthalene sulfonate and formaldehyde condensate thereof, alkyl benzene sulfonate, alkyl naphthalene sulfonate, alkyl diphenyl ether disulfonate, α-olefin sulfonate, lignin sulfonate, polyoxyethylene alkyl phenyl ether sulfonate, and dialkyl sulfosuccinate. Examples of sulfates include alkyl sulfate, polyoxyethylene alkyl ether sulfate, and polyoxyethylene alkyl phenyl ether sulfate. Examples of phosphates include polyoxyethylene alkyl aryl ether phosphate and polyoxyethylene tristyryl phenyl ether phosphate. Examples of carboxylates include fatty acid salt and polycarboxylic acid salt. Examples of nonionic surfactants include polyoxyethylene alkyl ether, polyoxypropylene alkyl ether, polyoxyethylene polyoxypropylene alkyl ether, polyoxyethylene distyryl phenyl ether, polyoxyethylene tristyryl phenyl ether, sucrose fatty acid ester, sorbitan fatty acid ester, polyoxyethylene sorbitan fatty acid ester, glycerol fatty acid ester, polyoxyethylene fatty acid ester, polyoxyethylene alkylamine, alkyl alkanolamide, polyoxyethylene polyoxypropylene block copolymer, alkyl polyglycoside, and acrylic co-polymer.

The suspension of the present invention comprises the present surfactant(s) in an amount of usually 0.5 to 30% by weight, preferably 1 to 20% by weight or 1 to 15% by weight.

The suspension of the present invention comprises water. Examples of water include ion-exchanged water, tap water, and underground water.

The suspension of the present invention comprises water in an amount of usually 30 to 98% by weight, preferably 40 to 90% by weight.

The suspension of the present invention may optionally comprise any other auxiliary agents for formulation.

Examples of other auxiliary agents for formulation include thickeners, preservatives, antifreeze agents, and antifoam agents. Suitable thickeners are polysaccharides such as xanthan gum, clays, and silicates. When the suspension of the present invention comprises a thickener, the content of the thickener in total amount of the suspension of the present invention is usually 0.05 to 5% by weight, preferably 0.07 to 3% by weight. Suitable preservatives are isothiazolinone preservatives. When the suspension of the present invention comprises a preservative, the content of the preservative in total amount of the suspension of the present invention is usually 0.05 to 0.5% by weight, preferably 0.1 to 0.3% by weight. Suitable antifreeze agents are ethylene glycol, propylene glycol, urea, and glycerol. When the suspension of the present invention comprises an antifreeze agent, the content of the antifreeze agent in total amount of the suspension of the present invention is usually 1 to 10% by weight, preferably 2 to 8% by weight. Suitable antifoam agents are silicone-based antifoam agents. When the suspension of the present invention comprises an antifoam agent, the content of the antifoam agent in total amount of the suspension of the present invention is usually 0.01 to 1% by weight, preferably 0.05 to 0.5% by weight. The suspension of the present invention comprises mefentrifluconazole, the present surfactant(s), and water in a total amount of 50% by weight or more, 60% by weight or more, or 70% by weight or more. In addition, the suspension of the present invention comprises mefentrifluconazole, the present surfactant(s), water, and a thickener in a total amount of 55% by weight or more, 65% by weight or more, or 75% by weight or more.

The suspension of the present invention may further comprise one or more other pesticidally active ingredients. The other pesticidally active ingredient is preferably a solid pesticidally active ingredient.

The zeta potential of the suspension of the present invention is −48 mV or less, preferably −52 mV or less, or −52.7 mV or less. In addition, the zeta potential of the suspension of the present invention is −80 mV or more, preferably −79.8 mV or more. The zeta potential, as used herein, refers to the zeta potential measured by the electrophoretic light scattering method, and the zeta potential of the aqueous suspension is measured using a zeta potential measuring device whose measurement principle is the electrophoretic light scattering method. As the zeta potential measurement device, Zetasizer Nano Series (for example, Zetasizer Nano ZSP, Zetasizer Nano ZS, Zetasizer Nano Z, and Zetasizer Nano ZS90) that are zeta potential measurement devices manufactured by Malvern Panalytical Ltd. are used. Specifically, the aqueous suspension is diluted with ion-exchanged water 200 times, a capillary cell is filled with the resultant sample, and the zeta potential of the aqueous suspension is measured at a temperature of 25° C. using any zeta potential measurement device of the Zetasizer Nano Series.

The suspension of the present invention can be prepared by methods known per se for the preparation of SCs, for example by mixing mefentrifluconazole, the present surfactant(s), and water, and, optionally further other auxiliary agents for formulation.

The method for producing the suspension of the present invention will be exemplified below.

A1) One or more pesticidally active ingredients, the present surfactant(s), and water, and, if necessary, auxiliary agents for formulation are mixed to obtain a suspension. As the pesticidally active ingredients, mefentrifluconazole and, if necessary, other pesticidally active ingredients can be used.
A2) The obtained suspension is fed to a grinder such as a bead mill to grind the pesticidally active ingredient in the suspension, thereby obtaining a suspension (hereinafter referred to as a ground suspension).
A3) One or more thickeners, one or more antifreeze agents and the like are added to the obtained ground suspension as necessary, and mixed to obtain a suspension of the present invention.

In the case of adding a part, not the entire amount, of the present surfactant in the step A1), the remaining present surfactant is added to the ground suspension in the step A3) after grinding. The operation of adding the present surfactant in each of the steps A1) and A3) is referred to as divided addition of the surfactant herein.

The total amount of the present surfactant to be added, and the type of the grinder used and its operating conditions (for example, bead size in the case of a bead mill), in the step of obtaining the ground suspension in the above step A2), are appropriately adjusted to adjust the zeta potential of the suspension of the present invention within the range of −48 to −80 mV. The zeta potential of the suspension of the present invention can be adjusted also by performing divided addition of the surfactant to appropriately adjust the amount of the surfactant to be added in the step of obtaining the suspension in the above step A1).

Plant diseases can be controlled by applying the suspension of the present invention to plants or their habitat.

A user applies the suspension of the present invention usually from a knapsack sprayer, a spray tank, a spray plane, or an irrigation system. Usually, the suspension of the present invention is diluted with water to the desired application concentration and the spray liquor is obtained. Usually, 20 to 2000 L, preferably 50 to 400 L, of the spray liquor are applied per hectare.

The application rate of the suspension of the present invention may be varied depending on a type of plant, a type or a frequency of an occurrence of plant diseases to be controlled, an application period, an application method, an application site, a climate condition and the like. The application rate of the suspension of the present invention is usually 10 to 100 g per hectare as an amount of mefentrifluconazole.

### EXAMPLES

Hereinafter, the present invention will be described in more detail by way of examples and test examples.

First, the components used for the preparation of an aqueous suspension are indicated below.

Rhodasurf 860/P (polyoxyethylene alkyl ether, manufactured by Solvay)
Soprophor FLK (40% by weight of polyoxyethylene tristyryl phenyl ether phosphate and 60% by weight of propylene glycol, manufactured by Solvay)
Atlox 4913 (30 to 35% by weight of an acrylic copolymer, and 65 to 70% by weight, in total, of propylene glycol and water, manufactured by Croda)
XIAMETER ACP-1500 (silicone-based antifoam agent, manufactured by Toray Dow Corning)
KELZAN S (xanthan gum, manufactured by CP Kelco),
VEEGUM R (magnesium aluminum silicate, manufactured by R. T. Vanderbilt Co., Inc.)
Propylene glycol (manufactured by Adeka)

### Example 1

Ten (10) parts by weight of mefentrifluconazole, 1.2 parts by weight of Rhodasurf 860/P, 0.2 parts by weight of XIAMETER ACP-1500, and 74.1 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for wet grinding, thereby obtaining 85.5 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

85.5 parts by weight of the ground suspension, 1.2 parts by weight of Rhodasurf 860/P and 13.3 parts by weight of the thickener-containing liquid were mixed to obtain an aqueous suspension of the present invention (hereinafter referred to as Present Suspension 1).

### Example 2

Ten (10) parts by weight of mefentrifluconazole, 1.2 parts by weight of Rhodasurf 860/P, 3 parts by weight of Soprophor FLK, 0.2 parts by weight of XIAMETER ACP-1500, and 72.3 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for wet grinding, thereby obtaining 86.7 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

86.7 parts by weight of the ground suspension and 13.3 parts by weight of the thickener-containing liquid were mixed to obtain an aqueous suspension of the present invention (hereinafter referred to as Present Suspension 2).

### Example 3

Ten (10) parts by weight of mefentrifluconazole, 4 parts by weight of Atlox 4913, 0.2 parts by weight of XIAMETER ACP-1500, and 72.5 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for wet grinding, thereby obtaining 86.7 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

86.7 parts by weight of the ground suspension and 13.3 parts by weight of the thickener-containing liquid were mixed to obtain an aqueous suspension of the present invention (hereinafter referred to as Present Suspension 3).

### Example 4

Ten (10) parts by weight of mefentrifluconazole, 3 parts by weight of Soprophor FLK, 0.2 parts by weight of XIAMETER ACP-1500, and 67.5 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for wet grinding, thereby obtaining 80.7 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

80.7 parts by weight of the ground suspension, 6 parts by weight of Soprophor FLK, and 13.3 parts by weight of the thickener-containing liquid were mixed to obtain an aqueous suspension of the present invention (hereinafter referred to as Present Suspension 4).

### Example 5

Ten (10) parts by weight of mefentrifluconazole, 4 parts by weight of Atlox 4913, 0.2 parts by weight of XIAMETER ACP-1500, and 68.5 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for wet grinding, thereby obtaining 82.7 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

82.7 parts by weight of the ground suspension, 4 parts by weight of Atlox 4913, and 13.3 parts by weight of the thickener-containing liquid were mixed to obtain an aqueous suspension of the present invention (hereinafter referred to as Present Suspension 5).

### Comparative Example 1

Ten (10) parts by weight of mefentrifluconazole, 1.2 parts by weight of Rhodasurf 860/P, 0.2 parts by weight of XIAMETER ACP-1500, and 75.3 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for wet grinding, thereby obtaining 86.7 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

86.7 parts by weight of the ground suspension and 13.3 parts by weight of the thickener-containing liquid were mixed to obtain an aqueous suspension (hereinafter referred to as Comparative Suspension 1).

### Comparative Example 2

Ten (10) parts by weight of mefentrifluconazole, 12 parts by weight of Atlox 4913, 0.2 parts by weight of XIAMETER ACP-1500, and 64.5 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for wet grinding, thereby obtaining 86.7 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

86.7 parts by weight of the ground suspension and 13.3 parts by weight of the thickener-containing liquid were mixed to obtain an aqueous suspension (hereinafter referred to as Comparative Suspension 2).

### Measurement of Zeta Potential of Aqueous Suspension

For each of Present Suspensions 1 to 5 and Comparative Suspensions 1 and 2, the aqueous suspension was diluted with ion-exchanged water 200 times, a capillary cell was filled with the resultant sample, and the zeta potential of the aqueous suspension was measured under the condition: a temperature of 25° C. using a zeta potential measurement device (Zetasizer Nano ZSP, manufactured by Malvern Panalytical Ltd.). The results are indicated in Tables 1 and 2.

### Test Example 1

For each of Present Suspensions 1 to 5 and Comparative Suspensions 1 and 2, 10 g of the aqueous suspension was placed in a 10-mL glass vial and stored for 2 weeks at 54° C., and, thereafter, the degree of separation was measured. The degree of separation was calculated according to the following formula (I):

Degree of separation (%)=y/x×100 (I)

wherein x represents the height (mm) of the whole aqueous suspension in the vial, and y represents the height (mm) of a supernatant formed by separation.

The results are indicated in Tables 1 and 2.

TABLE 1

| | Present | Present | Present | Present | Present |
|---|---|---|---|---|---|
| | Suspen- | Suspen- | Suspen- | Suspen- | Suspen- |
| | sion 1 | sion 2 | sion 3 | sion 4 | sion 5 |
| Zeta potential | −79.8 | −78.7 | −61.2 | −60.5 | −52.7 |
| (mV) | | | | | |
| Degree of | 20 | 6 | 6 | 13 | 6 |
| separation (%) | | | | | |

TABLE 2

| | Comparative | Comparative |
|---|---|---|
| | Suspension 1 | Suspension 2 |
| Zeta potential | −80.5 | −42.9 |
| (mV) | | |
| Degree of | 42 | 25 |
| separation (%) | | |

What is claimed is:

1. A formulation comprising mefentrifluconazole and an antifreeze agent selected from propylene glycol and glycerol.

2. The formulation according to claim 1, wherein the formulation is an aqueous suspension concentrate.

3. The formulation according to claim 1, wherein a weight ratio of mefentrifluconazole to the antifreeze agent is from 1:0.1 to 1:1.

4. A method for controlling plant diseases comprising a step of applying the formulation according to claim 1 to plants or their habitat.
